(19) United States
(12) Patent Application Publication
(10) Pub. No.: US 2009/0207123 A1
(43) Pub. Date: Aug. 20, 2009

(54) BACKLIGHT DRIVING APPARATUS AND DRIVING METHOD THEREOF

(76) Inventors: HUN-JOO KIM, Asan-si (KR); Jin-Woo Park, Cheonan-si (KR); Young-Suk Ha, Uiwang-si (KR)

Correspondence Address: F. CHAU & ASSOCIATES, LLC, 130 WOODBURY ROAD, WOODBURY, NY, 11797, US

(21) Appl. No.: 12/277,660

(22) Filed: Nov. 25, 2008

(30) Foreign Application Priority Data
Feb. 14, 2008 (KR) 2008-013343

(51) Int. Cl. G09G 3/36

(52) U.S. Cl. 345/102

(57) ABSTRACT

A backlight driving apparatus and a driving method thereof, in which the backlight driving apparatus includes a driving unit and a controller. The driving unit boosts an input voltage in response to a duty ratio of a control signal and provides the boosted input voltage to an LED array. The controller increases the duty ratio of the control signal in a step-by-step fashion by comparing a preset target value with a sequentially increasing step-setting value if a driving start signal is enabled.

### CROSS-REFERENCE TO RELATED APPLICATION

This application relies for priorities upon Korean Patent Application No. 2008-13343 filed on Feb. 14, 2008, the contents of which are herein incorporated by reference in their entirety.

### BACKGROUND

1. Technical Field

The present disclosure relates to a backlight driving apparatus and a driving method thereof More specifically, the present disclosure relates to a backlight driving apparatus for a liquid crystal display (LCD) and a driving method thereof.

2. Discussion of Related Art

In general, an LCD includes a thin film transistor substrate and a color filter substrate, which are aligned such that electrodes thereof face each other, and a liquid crystal layer interposed between the two substrates. When a voltage is applied to the electrodes to generate an electric field, the liquid crystals move due to the electric field, thereby displaying an image according to light transmittance that varies depending on the alignment of the liquid crystal layer.

An LCD is a non-light emitting display device and requires a backlight unit having a light source and a backlight driving apparatus that drives the light source using, for example, a PWM (pulse width modulation) control signal. A fluorescent lamp or an LED (light emitting diode) is mainly used as the light source for the backlight unit.

Because the LED has a faster response speed than the fluorescent lamp and superior anti-shock performance, and freely varies a brightness of the light and the color temperature by controlling the electric current flowing in red, green and blue LEDs, the LED has been recently favored as the light source for the backlight unit.

If an external driving start signal is provided in an enabled state, however, a conventional backlight driving apparatus instantaneously changes a duty ratio of the PWM control signal from zero to a duty ratio corresponding to a target brightness, so that the LED emits light with the target brightness. Such a change in the duty ratio of the PWM control signal is represented as a change in electric current flowing in the LED. Because such a change in the electric current instantaneously changes a black brightness to the target brightness, a flickering phenomenon occurs that is recognized by the user.

Furthermore, if the external driving start signal is enabled, the conventional backlight driving apparatus generates a PWM control signal having a duty ratio greater than the duty ratio corresponding to the target brightness, because the PWM control signal is over-compensated by a feedback signal that provides a constant voltage to the LED. Thus, the LED suddenly emits light with brightness higher than the target brightness, which is called the “splash phenomenon”.

### SUMMARY OF THE INVENTION

An exemplary embodiment of the present invention provides a backlight driving apparatus capable of gradually changing the brightness of an LED by varying the duty ratio of a PWM control signal in a step-wise fashion.

An exemplary embodiment of the present invention also provides a method of driving the backlight driving apparatus.

In an exemplary embodiment of the present invention, a backlight driving apparatus includes a driving unit and a controller. The driving unit boosts an input voltage in response to a duty ratio of a control signal and provides the boosted input voltage to an LED array. The controller increases the duty ratio of the control signal in a step-by-step fashion by comparing a preset target value with a sequentially increasing step-setting value if a driving start signal is enabled.

The step-setting value includes a plurality of voltage values that sequentially increase. The voltage values can be increased regularly or irregularly.

The backlight driving apparatus further includes a memory that stores the step-setting value. The controller reads out the step-setting value from the memory.

Furthermore, the controller generates the step-setting value by increasing a preset initial value regularly or irregularly. The initial value is a default value assigned as the initial step-setting value in order to prevent a protection function of the controller from being abnormally performed.

Furthermore, the LED array includes a plurality of LEDs, and emits light with brightness proportional to the electric current generated by the boosted input voltage.

In an exemplary embodiment of the present invention, a backlight driving method is provided as follows. An initial value is assigned to a step-setting value if a driving start signal is provided in an enabled state. A duty ratio of a control signal is determined by using a difference between the step-setting value and a target value. The step-setting value is increased. Then, the duty ratio of the control signal is increased by using the difference between the increased step-setting value and the target value.

In the increasing of the step-setting value, a preset target value is compared with the step-setting value. If the step-setting value is smaller than the target value, the step-setting value is increased.

In an exemplary embodiment of the present invention, a backlight driving method is provided as follows. The hardware is initialized to set a duty ratio of a control signal, which is determined by a difference between a feedback signal and a preset target value, as a dummy value. The feedback signal is blocked if a driving start signal is enabled. The duty ratio of the control signal is sequentially increased by comparing the target value with a sequentially increasing step-setting value. Then, an input voltage is provided to an LED array in response to the duty ratio of the control signal.

In providing the input voltage to the LED array in response to the duty ratio of the control signal, a blocking of the feedback signal is released if the step-setting value exceeds the target value. Then, the duty ratio of the control signal is determined by comparing the target value with the feedback signal.

According to the above-described exemplary embodiment, the brightness of an LED may be gradually changed by varying the duty ratio of the PWM control signal step-by-step if a driving start signal is provided in an enabled state, so that flicker caused by instantaneous brightness change during initial driving and the splash phenomenon caused by over compensation of the PWM control signal may be prevented from occurring.

### BRIEF DESCRIPTION OF THE DRAWINGS

Exemplary embodiments of the present invention will be understood in more detail from the following descriptions taken in conjunction with the accompanying drawings, wherein:

FIG. 1 is a block diagram showing an exemplary embodiment of a backlight driving apparatus according to the present invention;

FIG. 2 is a circuit diagram illustrating an exemplary embodiment of the backlight driving apparatus and a feedback signal shown in FIG. 1;

FIG. 3 is a circuit diagram illustrating an exemplary embodiment of the backlight driving apparatus and the feedback signal shown in FIG. 1;

FIG. 4 is a flowchart illustrating a backlight driving method according to an exemplary embodiment of the present invention;

FIG. 5 is a detailed flowchart illustrating the soft start step shown in FIG. 4;

FIG. 6 is a graph illustrating a variation in brightness according to an operation of the conventional backlight driving apparatus; and

FIG. 7 is a graph illustrating a variation in brightness according to an operation of a backlight driving apparatus according to an exemplary embodiment of the present invention.

### DETAILED DESCRIPTION OF EXEMPLARY EMBODIMENTS

Hereinafter, exemplary embodiments of the present invention will be explained in detail with reference to the accompanying drawings.

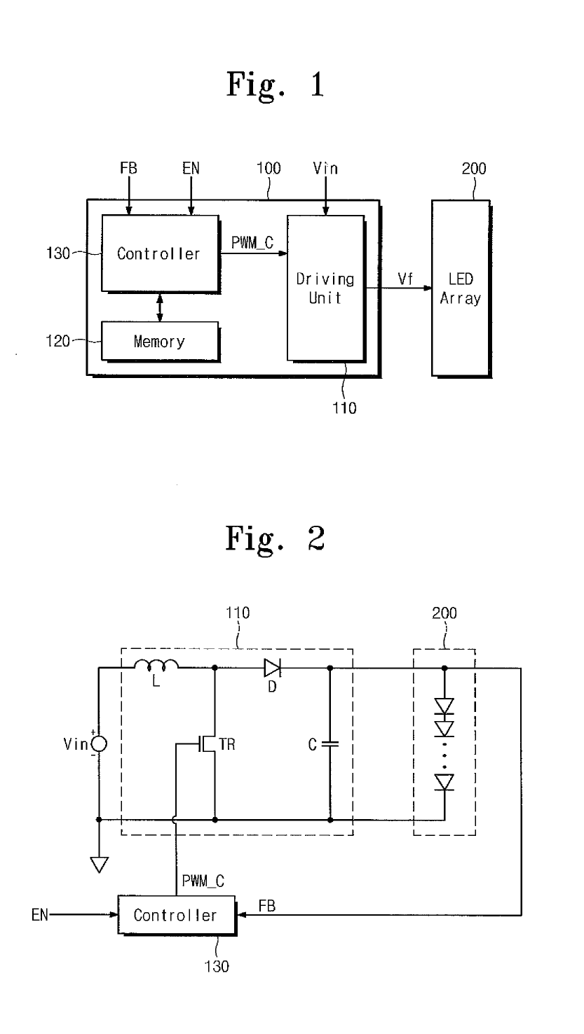

FIG. 1 is a block diagram showing an exemplary embodiment of a backlight driving apparatus according to the present invention.

Referring to FIG. 1, the backlight driving apparatus 100 includes a driving unit 110, a memory 120 and a controller 130.

The driving unit 110 boosts an input voltage Vin in response to a PWM control signal PWM_C provided from the controller 130, and provides the boosted voltage Vf to an LED array 200. The PWM control signal PWM_C is a pulse signal that intermittently controls supply of the boosted voltage Vf to the LED array 200, and has a duty ratio that intermittently controls the supply of the boosted voltage Vf. The input voltage Vin may be provided from an external SMPS (switch mode power supply).

The LED array 200 includes red R, green G, and blue B LEDs that emit light with brightness in proportion to the electric current flowing therein. The electric current flowing in the LED array 200 is determined by the boosted voltage Vf, which is provided from the driving unit 110, and resistance characteristics of the LED array 200. The driving unit 110 may control the red R, green G, and blue B LEDs by using the individual PWM control signal PWM_C.

The memory 120 stores a step-setting value, a target value and characteristic information of the LED array 200. The step-setting value includes plural voltage values that sequentially increase in order to change the duty ratio of the PWM control signal PWM_C in a step-by-step fashion. The voltage values may be set in a range between an initial value and a target value by dividing the range regularly or irregularly.

The initial value is a default value assigned as an initial step-setting value. The initial value is used to prevent the controller 130 from abnormally performing a protection function, which shuts down a BLU (backlight unit), if electric current at a predetermined level or less is provided from a converter (not shown). For example, the initial value may be a voltage value greater than 0V. In addition, the target value is a voltage value corresponding to target brightness of the LED array 200. Furthermore, the characteristic information of the LED array 200 includes a resistance value of the LED array 200.

If an external driving start signal EN is provided in an enabled state, the controller 130 performs a soft start operation of sequentially increasing the duty ratio of the PWM control signal PWM_C gradually by comparing the target value read out from the memory 120 with the step-setting value that sequentially increases, and then providing the driving unit 110 with the duty ratio of the PWM control signal PWM_C. The driving start signal EN may be provided from the external SMPS (not shown).

To this end, the controller 130 includes a comparator (not shown), which has an inversion terminal that receives the target value, and a non-inversion terminal that receives the step-setting value, and provides the difference between the target value and the step-setting value as the PWM control signal PWM_C. The controller 130 may further include a first switch (not shown), which prevents a feedback signal FB from being provided to the non-inversion terminal of the comparator, and a second switch (not shown), which allows the step-setting value to be provided to the non-inversion terminal of the comparator, if the driving start signal EN is enabled.

If the duty ratio of the PWM control signal PWM_C increases through the soft start operation and the brightness of the LED array 200 reaches the target value, the controller 130 constantly maintains the duty ratio of the PWM control signal PWM_C by comparing the target value read out from the memory 120 with the feedback signal FB, thereby controlling the LED array 200 to emit light with constant brightness.

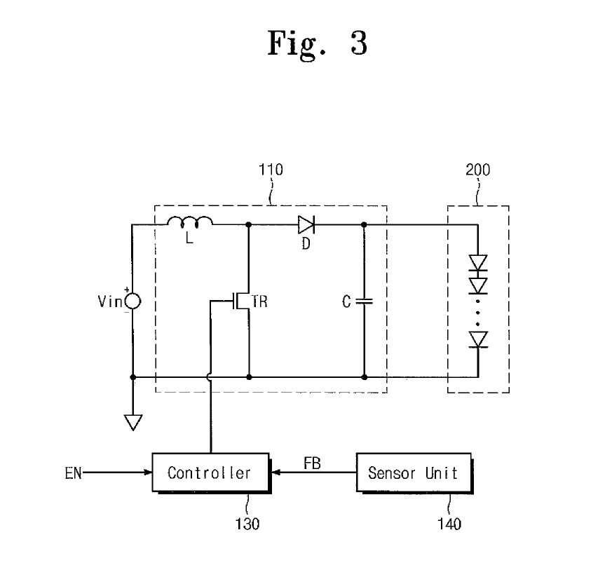

FIG. 2 is a circuit diagram illustrating an exemplary embodiment of the driving unit 110 with a feedback signal, as shown in FIG. 1.

Referring to FIG. 2, the driving unit 110 includes an inductor L and a diode D, which are serially connected with a plus (+) terminal of input voltage Vin, a capacitor C, which is connected between the diode D and a minus (−) terminal of the input voltage Vin, and a switch device TR connected between a connection node of the inductor L and the diode D and the minus (−7) terminal of the input voltage Vin.

The switch device TR may include a MOSFET (metal oxide semiconductor field effect transistor) that switches the input voltage Vin in response to the PWM control signal PWM_C. The LED array 200 includes a plurality of LEDs serially connected to each other and is connected in parallel with the capacitor C of the driving unit 110. In the exemplary embodiment, the feedback signal FB is the boosted voltage Vf provided to the LED array 200.

Hereinafter, an operation of the driving unit 110 will be described. If the switch device TR is turned on in response to the PWM control signal PWM_C provided by the controller 130, electric current generated by the input voltage Vin flows through the inductor L and the switch device TR, so that energy is stored in the inductor L. Next, if the switch device TR is turned off in response to the PWM control signal PWM_C provided by the controller 130, the boosted voltage Vf, which corresponds to the sum of the input voltage Vin and the energy accumulated in inductor L, is transferred to the LED array 200 through the diode D. The boosted voltage Vf is smoothed by the capacitor C and has an amplitude greater than or equal to the input voltage Vin.

FIG. 3 is a circuit diagram illustrating an exemplary embodiment of the driving unit 110 and a feedback signal, as shown in FIG. 1.

Referring to FIG. 3, the feedback signal FB is a detection signal detected by a sensor unit 140. The sensor unit 140 includes a variable resistor having a value that linearly varies depending on a variation in the temperature around the LED array 200. A voltage detected by the variable resistor is used as the feedback signal FB provided to the controller 130.

Because the circuit configurations and operations of the driving unit 110, the LED array 200 and the like may be easily understood by those of ordinary skill in the art with reference to FIG. 2, the detailed descriptions thereof will be omitted.

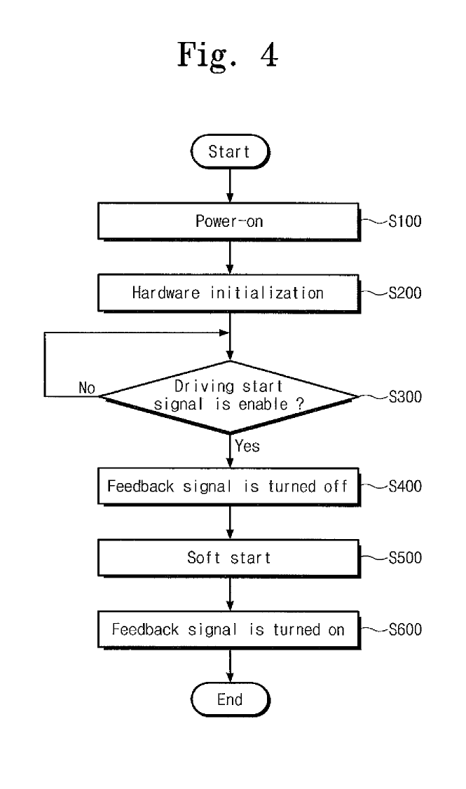

FIG. 4 is a flowchart illustrating the backlight driving method according to an exemplary embodiment of the present invention.

Referring to FIG. 4, the backlight driving method includes a power-on step (S100), a hardware initialization step (S200), an enable state determination step (S300), a turn-off of a feedback signal (S400), a soft start step (S500) and a turn-on of the feedback signal (S600).

In the power-on step (S100), the backlight driving apparatus receives the input voltage Vin from the SMPS. The input voltage Vin may be 24V. At this time, after the driving start signal EN is provided in an enabled state, the backlight driving apparatus provides the driving voltage to the LED array.

In the hardware initialization step (S200), hardware is initialized so that the backlight driving apparatus operates normally, and the duty ratio of the PWM control signal PWM_C is set using a dummy value randomly selected by the controller.

In the enable state determination step (S300), the controller monitors whether the driving start signal EN is provided in an enabled state. The controller may determine that the driving start signal EN has been enabled when a driving start signal EN of 5V is provided from the SMPS. If the driving start signal EN is provided in an enabled state, the controller performs the turn-off operation of the feedback signal (S400) and the soft start operation (S500). If the driving start signal EN is not provided in an enabled state, however, the controller may periodically monitor whether the driving start signal EN is provided in an enabled state.

In the turn-off of the feedback signal (S400), the feedback signal input to the comparator of the controller is blocked, and the step-setting value read out from the memory is input to the comparator of the controller through a predetermined path. This step may be performed by the first and second switches that perform a switching function in response to the driving start signal EN.

In the soft start step (S500), after the turn-off of the feedback signal (S400), the controller sequentially reads out the step-setting value from the memory, and gradually increases the duty ratio of the PWM control signal PWM_C by using a result obtained by comparing the read-out step-setting value with the target value. The step-setting value corresponds to a plurality of voltage values that sequentially increase. These voltage values may increase regularly or irregularly.

In the present exemplary embodiment, an example of using the preset step-setting value stored in the memory has been described. The scope of the present invention, however, is not limited thereto. For example, the controller may use a step-setting value, which is generated using a counter and a timer, in the soft start step (S500). More specifically, the controller may generate the step-setting value by gradually increasing an initial step-setting value through the counter during predetermined time periods indicated by the timer.

In the turn-on of the feedback signal (S600), if the brightness of the LED array reaches the target value through the soft start step (S500), the controller compares the target value read out from the memory with the feedback signal, and constantly maintains the duty ratio of the PWM control signal PWM_C by using the comparison result.

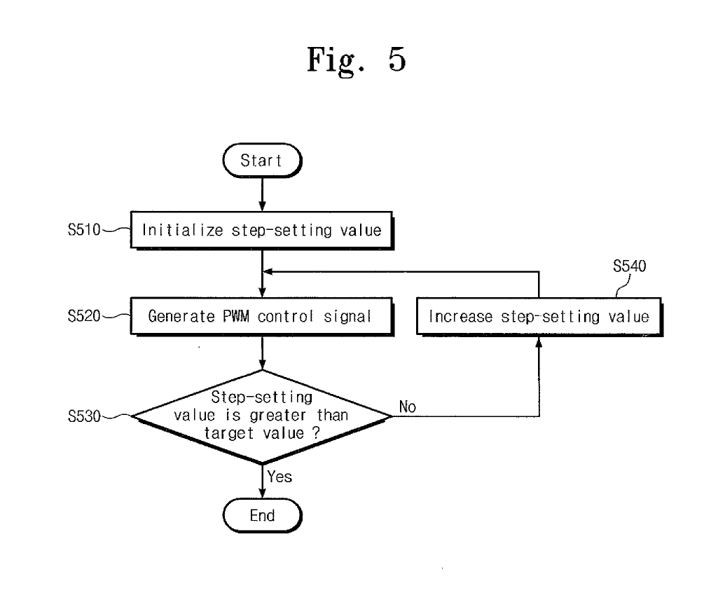

FIG. 5 is a detailed flowchart illustrating the soft start step shown in FIG. 4.

Referring to FIG. 5, the soft start step (S500) includes an initialization step (S510) for the step-setting value, a PWM control signal generation step (S520), and a determination step (S530) for the step-setting value, and an increasing step (S540) to increase the step-setting value.

In the initialization step (S510), an initial value is allocated to the step-setting value. The initial value is an original step-setting value compared with the target value, and a random value greater than 0V and smaller than the target value can be designated as a default value.

In the PWM control signal generation step (S520), the duty ratio of the PWM control signal PWM_C is determined by comparing the step-setting value allocated as the initial value with the target value. The duty ratio of the PWM control signal PWM_C may control the brightness of the LED array by adjusting the electric current flowing in the LED array.

In the determination step (S530), whether the step-setting value exceeds the target value is determined.

In the increasing step (S540), if the step-setting value does not exceed the target value as a result of the determination step (S530), the step-setting value is increased regularly or irregularly. The gradually increasing step-setting value may be read out from the memory or generated using the counter and the timer.

Then, the procedure repeats the step of generating the control signal (S520), in which the duty ratio of the PWM control signal PWM_C is determined by comparing the increased step-setting value with the target value, the step S530, in which whether the increased step-setting value exceeds the target value is determined, and the step S540 in which, if the increased step-setting value does not exceed the target value as a result of step S530, the step-setting value is increased regularly or irregularly. If the increased step-setting value exceeds the target value, however, the soft start step ends.

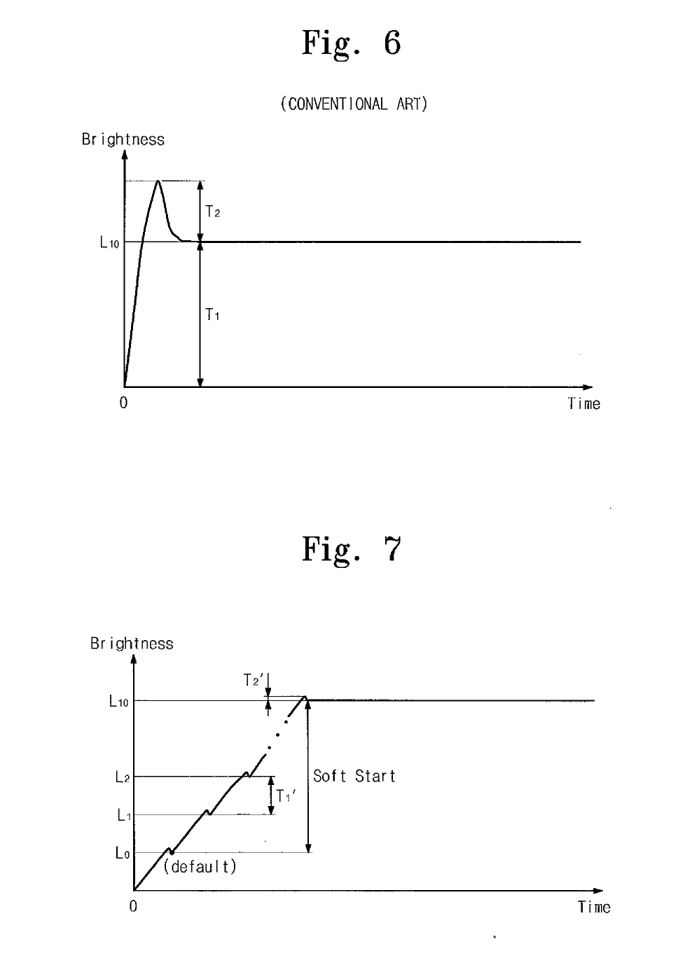

FIG. 6 is a graph illustrating a variation in brightness according to an operation of the conventional backlight driving apparatus.

Referring to FIG. 6, when the target brightness is a level L₁₀, if the driving start signal is enabled, the conventional backlight driving apparatus instantaneously changes the brightness of the LED. Thus, flicker or the splash phenomenon may occur.

More specifically, T₁ indicates an interval, in which the conventional backlight driving apparatus instantaneously changes the duty ratio of the PWM control signal from zero to a duty ratio corresponding to the target brightness, so that the brightness of the LED instantaneously changes from black brightness to the target brightness. This may be recognized by a user as flicker.

Furthermore, T₂ indicates an interval, in which the conventional backlight driving apparatus over-compensates for the PWM control signal by using the feedback signal, so that the LED instantaneously emits light with a brightness higher than the target brightness. This may be recognized by a user as the splash phenomenon.

FIG. 7 is a graph illustrating variation in brightness corresponding to an operation of the backlight driving apparatus according to an exemplary embodiment of the present invention. In FIG. 7, L₀ is an initial brightness corresponding to the initial step-setting value allocated as the default value, and L₁₀ denotes the target brightness corresponding to the target value.

Referring to FIG. 7, if the driving start signal is enabled, the backlight driving apparatus according to an exemplary embodiment of the present invention changes the brightness of the LED gradually from the initial brightness L₀ to the target brightness L₁₀, thereby reducing the flicker or the splash phenomenon caused by the conventional backlight driving apparatus. In FIG. 7, the brightness of the LED is regularly increased step-by-step.

More specifically, T₁ denotes a sudden change interval of the brightness of the LED caused by change in the duty ratio of the PWM control signal. In the backlight driving apparatus according to an exemplary embodiment of the present invention, the duty ratio of the PWM control signal is gradually increased, so that the brightness of the LED may vary gradually. Thus, variation in the brightness of the LED is small as compared with T₁ of FIG. 6, and such minute variation of the brightness is rarely recognized by a user.

Next, T₂, denotes an interval in which light is emitted with over-compensation brightness according to the PWM control signal having been increased gradually. The backlight driving apparatus according to an exemplary embodiment of the present invention blocks the feedback signal and gradually increases the duty ratio of the PWM control signal based on the soft start scheme, thereby reducing an interval that may be recognized by a user as the splash phenomenon, as compared with T₂ of FIG. 6.

The backlight driving apparatus and the driving method thereof of an exemplary embodiment of the present invention may be applied to an LCD that employs an LED as its light source. The LCD includes a mobile communication apparatus and a multimedia apparatus, which require slimness and lightness, as well as a large television that requires low power consumption and slimness.

Although exemplary embodiments of the present invention have been described, it is understood that the present invention should not be limited to these exemplary embodiments but various changes and modifications can be made by one of ordinary skill in the art within the spirit and scope of the present invention as hereinafter claimed.

What is claimed is:

1. A backlight driving apparatus comprising:
a driving unit that boosts an input voltage in response to a duty ratio of a control signal and provides the boosted input voltage to a light emitting diode (LED) array; and
a controller that increases the duty ratio of the control signal in a step-by-step fashion by comparing a preset target value with a sequentially increasing step-setting value when a driving start signal is enabled.

2. The backlight driving apparatus of claim 1, wherein the step-setting value comprises a plurality of voltage values that sequentially increase.

3. The backlight driving apparatus of claim 2, wherein the voltage values are increased regularly or irregularly.

4. The backlight driving apparatus of claim 3, further comprising a memory that stores the step-setting value, and the controller reads out the step-setting value from the memory.

5. The backlight driving apparatus of claim 1, wherein the controller generates the step-setting value by increasing a preset initial value regularly or irregularly.

6. The backlight driving apparatus of claim 5, wherein the preset initial value is a default value assigned as an initial step-setting value in order to prevent a protection function of the controller from being performed.

7. The backlight driving apparatus of claim 1, wherein the LED array comprises a plurality of LEDs, and emits light with a brightness proportional to an electric current generated by the boosted input voltage.

8. A backlight driving method comprising:
allocating an initial value to a step-setting value when a driving start signal is provided in an enabled state;
determining a duty ratio of a control signal by using a difference between the step-setting value and a target value;
increasing the step-setting value; and
increasing the duty ratio of the control signal by using a difference between the increased step-setting value and the target value.

9. The backlight driving method of claim 8, wherein the increasing the step-setting value comprises comparing a preset target value with the step setting value, in which the step setting value is increased if the step setting value is smaller than the target value.

10. The backlight driving method of claim 9, wherein the initial value is a default value assigned as the initial step-setting value in order to prevent a protection function from being performed.

11. A backlight driving method comprising:
initializing a hardware unit to set a duty ratio of a control signal, which is determined by a difference between a feedback signal and a preset target value, as a dummy value;
turning off the feedback signal, in which the feedback signal is blocked when a driving start signal is enabled;
sequentially increasing the duty ratio of the control signal by comparing the target value with a sequentially increasing step-setting value; and
providing an input voltage to a light emitting diode (LED) array in response to the duty ratio of the control signal.

12. The backlight driving method of claim 11, wherein the step-setting value is sequentially increased between a preset initial value and the target value regularly or irregularly.

13. The backlight driving method of claim 12, wherein the preset initial value is a default value assigned as the initial step-setting value in order to prevent a protection function from being performed.

14. The backlight driving method of claim 11, wherein the providing the input voltage to the LED array in response to the duty ratio of the control signal comprises;
releasing blocking of the feedback signal when the step-setting value exceeds the target value; and
determining the duty ratio of the control signal by comparing the target value with the feedback signal.
